(19) United States
(12) Patent Application Publication
(10) Pub. No.: US 2025/0373404 A1
(43) Pub. Date: Dec. 4, 2025

(54) REDUCING RECEIVE BAND LEAKAGE IN A DUPLEXER

(71) Applicant: MaxLinear, Inc., Carlsbad, CA (US)

(72) Inventors: Curtis Ling, Carlsbad, CA (US); Anand Krishnasamy Anandakumar, San Diego, CA (US)

(73) Assignee: MaxLinear, Inc., Carlsbad, CA (US)

(21) Appl. No.: 19/221,367

(22) Filed: May 28, 2025

Related U.S. Application Data
(60) Provisional application No. 63/652,614, filed on May 28, 2024.

(51) Int. Cl. H04L 5/14

(52) U.S. Cl. CPC H04L 5/1461

(57) ABSTRACT

A method for reducing receive band leakage may include: sensing, at a full duplexer, passive intermodulation distortion and power amplifier distortion; generating, at a processing device, a passive intermodulation distortion and power amplifier distortion cancellation signal; and cancelling, on a receive path, the passive intermodulation distortion and power amplifier distortion using the passive intermodulation distortion and power amplifier distortion cancellation signal.

### RELATED APPLICATION

This application claims the benefit of U.S. Provisional Application No. 63/652,614, filed May 28, 2024, the disclosure of which is incorporated herein by reference in its entirety for all purposes.

The examples discussed in the present disclosure are related to reducing receive band leakage in a duplexer.

### BACKGROUND

Unless otherwise indicated herein, the materials described herein are not prior art to the claims in the present application and are not admitted to be prior art by inclusion in this section.

A duplexer may allow bi-directional communication over a path. In a duplexer, different signals may travel in opposite directions using a shared port. Duplexers may be subject to distortion.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a method for reducing receive band leakage may include one or more of sensing, at a full duplexer, passive intermodulation (PIM) distortion and power amplifier (PA) distortion; generating, at a processing device, a PIM distortion and PA distortion cancellation signal; or canceling, on a receive path, the PIM distortion and PA distortion using the PIM distortion and PA distortion cancellation signal.

In some examples, a device may include a duplexer and a processing device. The duplexer may sense PIM distortion and PA distortion. The processing device may generate a PIM distortion and PA distortion cancellation signal to cancel the PIM distortion and the PA distortion.

In some examples, a computer-readable storage medium may including computer executable instructions. The computer executable instructions, when executed by one or more processors, may cause a device to one or more of: sense, at a full duplexer, PIM distortion and power amplifier (PA) distortion; generate, at a processing device, a PIM distortion and PA distortion cancellation signal; or cancel, on a receive path, the PIM distortion and PA distortion using the PIM distortion and PA distortion cancellation signal.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1A illustrates an example radio frequency spectrum including passive intermodulation.

FIG. 1B illustrates an example radio frequency spectrum including passive intermodulation canceled by passive intermodulation cancellation.

FIG. 2 illustrates an example communication system configured to cancel passive intermodulation.

FIG. 3 illustrates an example block diagram showing the data path and control path for passive intermodulation cancellation.

FIG. 4 illustrates an example communication system configured to reduce receive band leakage.

FIG. 5 illustrates a flow diagram for reducing receive band leakage.

FIG. 6 illustrates a process flow used to reduce receive band leakage.

FIG. 7 illustrates a process flow for a method used to reduce receive band leakage.

FIG. 8 illustrates an example communication system.

FIG. 9 illustrates a diagrammatic representation of a machine in the example form of a computing device within which a set of instructions, for causing the machine to perform any one or more of the methods discussed herein, may be executed.

### DESCRIPTION

Examples of the present disclosure will be explained with reference to the accompanying drawings.

Receive band leakage may be distortion caused in the receive band when two or more signals transmit through a passive device with nonlinear properties. Receive band leakage may interfere with a received signal. Therefore, methods and devices for reducing receive band leakage may be useful.

In one example, receive band leakage may be reduced by sensing (e.g., at a full duplexer), passive intermodulation (PIM) distortion and PA distortion. The receive band leakage may be reduced by generating (e.g., at a processing device) a PIM distortion and PA distortion cancellation signal. The receive band leakage may be reduced by canceling (e.g., at a receive path) the PIM distortion and the PA distortion using the PIM distortion and PA distortion cancellation signal.

Examples of the present disclosure will be explained with reference to the accompanying drawings.

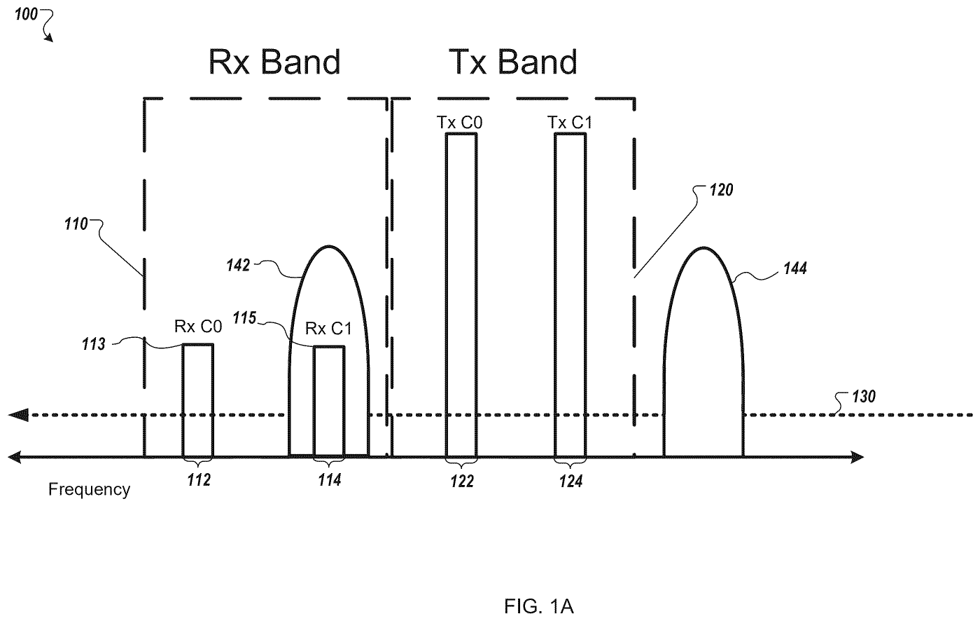

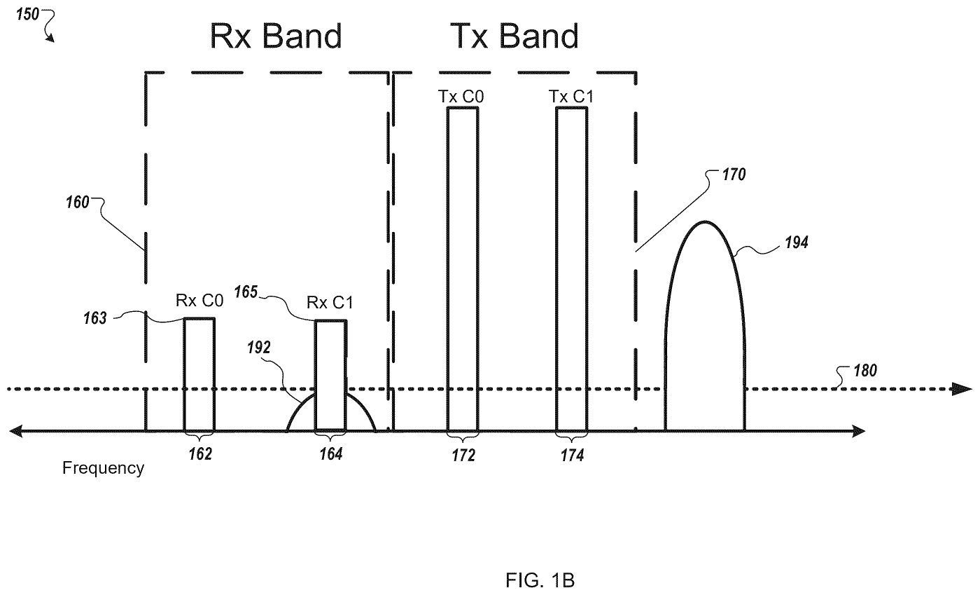

In some examples, as illustrated in FIG. 1A, a radio frequency (RF) spectrum 100 may include a receiving (Rx) frequency band 110 and a transmitting (Tx) frequency band 120. The Rx frequency band 110 may include an Rx channel Rx C0 112 and an Rx channel Rx C1 114. The Tx frequency band may include a Tx channel Tx C0 122 and a Tx channel Tx C1 124. When the received signal amplitude 113, 115 of a received signal in an Rx channel 112, 114 is greater than the Rx sensitivity threshold 130, the received signal may be sensed in the Rx channel 112, 114.

In some examples, however, the presence of intermodulation distortion (IMD) 142 may prevent a received signal in an Rx channel 114 from being sensed when the IMD 142 has a greater amplitude than the Rx sensitivity threshold 130 and the received signal amplitude 115. The intermodulation distortion 142, when greater than the Rx sensitivity threshold 130, may interfere with sensing the receiving signal in the Rx channel 114, as shown by the frequency and amplitude overlap between Rx channel Rx C1 114 and the intermodulation distortion 142. Other IMD may be present in unrelated frequency bands as shown by intermodulation distortion 144.

In some examples, as illustrated in FIG. 1B, an RF spectrum 150 may include: an Rx frequency band 160 having Rx channels Rx C0 162 with amplitude 163 and Rx C1 164 with amplitude 165, and a Tx frequency band 170 having Tx channels Tx C0 172 and Tx C1 174. The Rx sensitivity threshold 180 may indicate when intermodulation distortion 192 may interfere with an Rx signal in an Rx channel 164. In this example, the intermodulation distortion 192 is less than the Rx sensitivity threshold 180 in contrast to the intermodulation distortion 142 and the Rx sensitivity threshold 130 in FIG. 1A. Therefore, reducing the intermodulation distortion may enhance receiver sensitivity. Other IMD may be present in unrelated frequency bands as shown by intermodulation distortion 194.

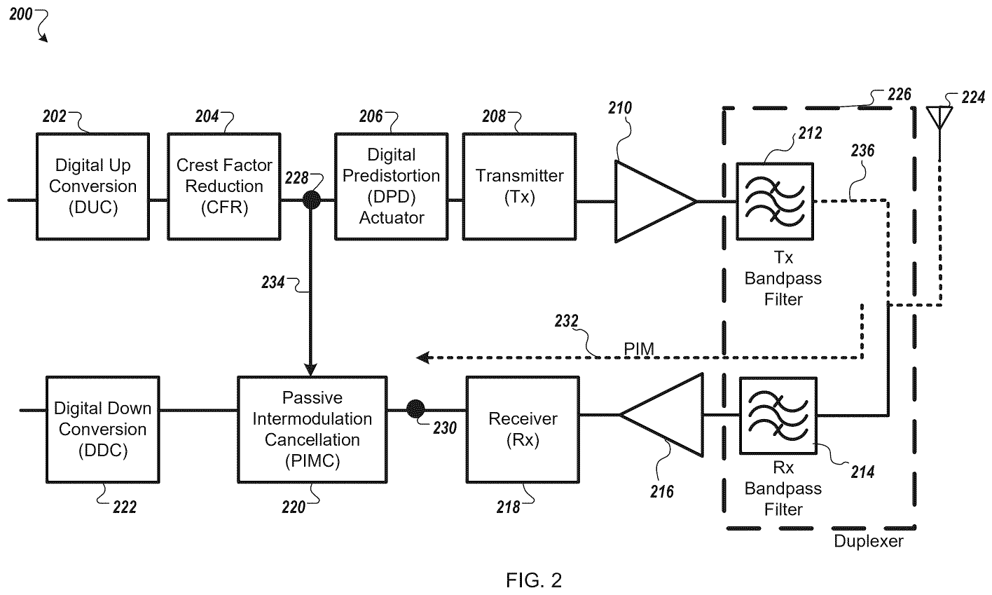

In some examples, as illustrated in FIG. 2, a communication system 200 may comprise one or more of a digital up conversion (DUC) block 202, a crest factor reduction (CFR) block 204, a digital pre-distortion actuator (DPD) 206, a transmitter (Tx) 208, a PA 210, a Tx bandpass filter 212, an Rx bandpass filter 214, a low noise amplifier 216, a receiver (Rx) 218, a passive intermodulation cancellation (PIMC) block 220, a digital down conversion (DDC) block 222, an antenna 224, a duplexer 226, or the like.

In some examples, a base station may be configured for enhanced receiver sensitivity. The base station may comprise a receiver (Rx) 218 configured to receive an Rx output signal in an Rx band. The base station may comprise a processing device (e.g., at the PIMC 220) configured to receive the Rx output signal 230 from the receiver 218 on an Rx path (e.g., the signal path from the antenna 224 to the Rx bandpass filter 214, to the low noise amplifier 216, to the receiver 218). The processing device may be configured to receive a CFR output signal 228 from a CFR 204 on a transmit (Tx) path (e.g., the signal path from the DUC 202 to the CFR 204). The processor may be configured to calibrate the CFR output signal 228 based on the Rx output signal 230 to generate a non-linear actuation (NA) input signal. The processor may be configured to generate an intermodulation distortion signal by using an NA function on the NA input signal.

In some examples, in the communication system 200, the CFR output 228 may be used to generate a cancellation signal to reduce internal PIM in the Rx output signal 230 and thereby enhance receiver sensitivity. In some examples, the communication system 200 may be configured to tap off a transmit signal to be used to generate a cancellation signal from a different output block on the transmit path (e.g., output from the DUC 202, the DPD 206, the Tx 208, the Tx bandpass filter 212, or the like). In some examples, the communication system 200 may be configured to tap off a receive signal from a different output block on the receiver path (e.g., output from the Rx bandpass filter 214, the low noise amplifier 216, the DDC 222, or the like). When the transmit signal is not tapped off at the CFR output 228 and the receiver signal is not tapped off at the Rx Out 230, the PIMC block may be reconfigured to cancel the PIM based on the particular signals received.

In some examples, tapping off at the CFR output 228 (by receiving the CFR output via the connection 234) may enhance the receiver sensitivity compared to other tap off locations on the transmit path. For example, tapping off a signal before DUC 202 may result in various types of distortion such as aliasing, aperture error, and quantization. Aliasing may occur when the sampling rate is too low, which may be the case before digital up-conversion because the component carriers may overlap. Moreover, tapping off after Tx 208 may result in under-sampling and/or may result in intermodulation products that are not at a proper frequency. Thus, tapping off at the CFR output 228 may provide intermodulation at the proper frequency for generating a passive intermodulation cancellation signal. The DPD 206 may be configured to match the output of the power amplifier 210 to the CFR output 228 so that the PIMC generated based on the CFR output 228 may match the signal producing the intermodulation distortion (e.g., a PIM source 232 arising from the signal path 236).

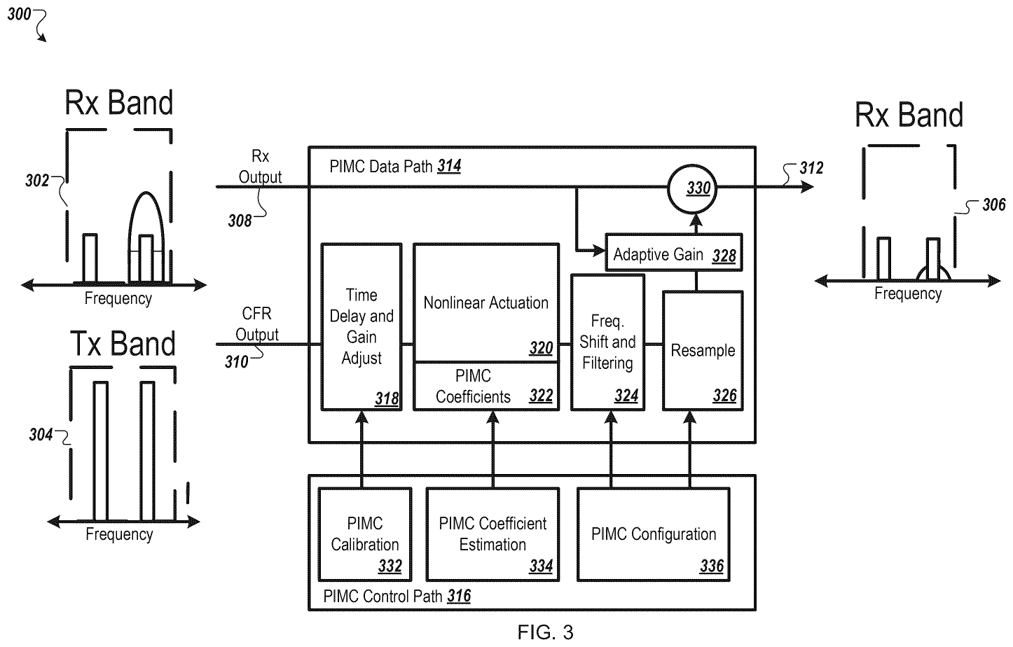

In some examples, when the transmit signal is tapped off at the CFR output 228 and the receiver signal is tapped off at Rx Out 230, the signal propagation, in the frequency domain, may be illustrated as shown in FIG. 3 in the PIMC system 300. The PIMC system 300 illustrates a PIMC data path 314 and a PIMC control path 316. The sub-blocks in the PIMC data path 314 process the data IQ samples in real-time as the samples become available. Hence, these sub-blocks may be implemented using high speed hardware logic. On the other hand, the sub-blocks in PIMC control path 316 provide configuration parameters and coefficients. These sub-blocks may be implemented using high speed hardware logic or software running on a host processor.

In some examples, a receiver signal (e.g., Rx output signal 308) in an Rx Band 302 may be received at the PIMC data path 314. The PIMC data path 314 may also be configured to receive a CFR output signal 310 in a Tx band 304. The PIMC data path 314 and PIMC control path 316 may be configured to generate a correct Rx signal 312 that may have reduced IMD compared to the Rx output signal 308 to facilitate enhanced receiver sensitivity, as shown by the Rx band 306.

In some examples, the CFR output signal 310 may be calibrated based on one or more time delay coefficients in a time delay and gain adjust operation 318. Alternatively, or in addition, the CFR output signal 310 may be calibrated based on one or more gain adjust coefficients. Alternatively, or in addition, the CFR output signal 310 may be calibrated based on one or more phase adjust coefficients. One or more of the time delay coefficients, the gain adjust coefficients, or the phase adjust coefficients may be computed as shown in operation 332 on the PIMC control path 316.

In some examples, the NA function may be computed, as shown in operation 320, using a non-linear function including one or more of: a look-up table (LUT), a polynomial, a wavelet function, a piecewise linear (PWL) function, or the like. The non-linear function may be computed using PIMC coefficients, as shown in operation 322. The PIMC coefficients may be estimated, as shown in operation 334, by computing a least squares solution using one or more of: closed-form using an inverse matrix, or gradient descent using a fixed step-size parameter, or conjugate-gradient descent using a dynamic step-size parameter. The PIMC coefficients may be estimated based on one or more parameters including leak factor, number of batches, or batch-size. The fixed step-size parameter or the dynamic step-size parameter may be configured based on one or more of closed-loop stability, estimated noise suppression, or a time of convergence. The PIMC coefficients may be sent to the PIMC coefficient 322 operation to be used in the nonlinear actuation operation 320.

In some examples, a frequency shift of the intermodulation distortion signal (i.e., the signal output from the nonlinear actuation operation 320) may be computed at operation 336 and applied at operation 324 to match a frequency location of passive intermodulation in the Rx output signal 308. Based on this frequency shift of the intermodulation distortion signal, one or more filters may be configured to remove signals outside a frequency range for the PIMC signal. Alternatively, or in addition, a multi-band filter may be configured to select an Rx frequency range to remove interleaved uplink and downlink frequency bands.

In some examples, the intermodulation distortion signal may be re-sampled, as shown in operation 326 to match an IQ sample rate of the Rx output signal 308 based on a re-sample ratio, as computed at operation 336, between the Rx output signal 308 and the CFR output signal 310.

In some examples, the PIMC data path 314 may comprise an adaptive filter configured to adjust a gain and/or phase of the intermodulation distortion signal, as shown in operation 328. The gain and/or phase may be adjusted based on an automatic gain control (AGC) error, a low noise amplifier (LNA) error, a temperature-induced error, or the like.

In some examples, a PIMC subtractor 330 may be configured to generate a corrected Rx signal based on the intermodulation distortion signal (i.e., the output from the nonlinear actuator 320, which may be processed by the frequency shift and filtering operation 324, the resampling operation 326, and/or the adaptive gain operation 328) and the Rx output signal 308.

In some examples, the PIMC data path 314 and/or PIMC control path 316 may be configured to generate a PIMC bypass signal. The PIMC bypass signal may prevent passive intermodulation cancellation from occurring. The PIMC bypass signal may be generated when one or more of: an antenna is being calibrated, a PA protection procedure is being performed, or PIM is not detected based on one or more of a frequency allocation or an estimated PIM correction level.

In some examples, the PIMC data path may comprise an on-board calibration unit or an on-board coefficient estimation engine. The on-board calibration unit may be configured to calibrate the CFR output signal 310 based on the Rx output signal 308 using adaptive calculation and adaptive adjustment. The on-board coefficient estimation engine may be configured to compute the NA function using one or more PIMC coefficients that may be calculated and updated based on radio traffic data (e.g., that may be received in real time).

In some examples, the PIMC data path 314 may be implemented using high-speed processing that may be implemented using a field-programmable gate array (FPGA) or an application specific integrated circuit (ASIC). The PIMC control path 316 may be implemented using an FPGA or ASIC, or may be implemented as computer-readable instructions executed by a processor.

When using a full duplexer, receive band leakage may occur. Receive band leakage may be reduced by using a higher order filter. However, using a higher order filter comes at a price—the amount of power consumed may be increased. For example, the duplexer may generate about 3 dB of loss under these circumstances. Therefore, reducing the amount of power consumption by reducing receive band leakage at a duplexer may be useful.

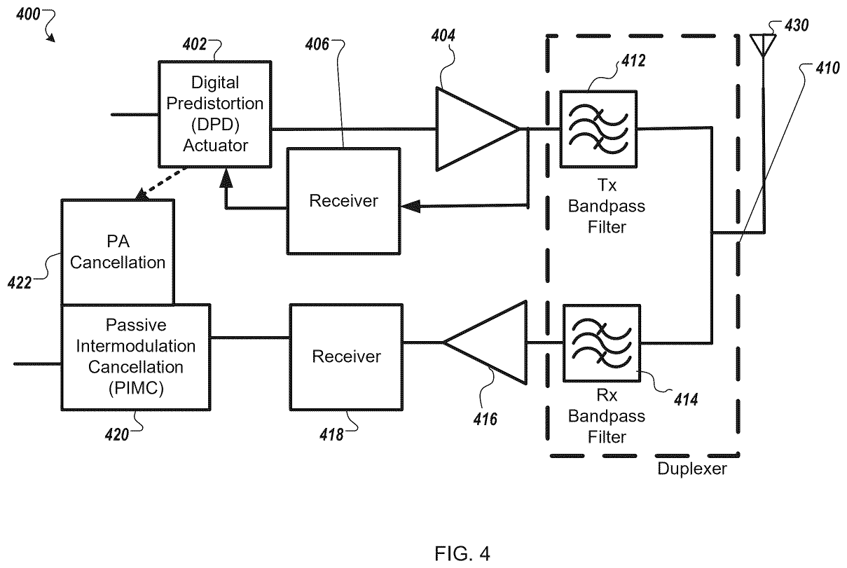

FIG. 4 illustrates an example communication system configured to reduce receive band leakage. In some examples, a communication system 400 may include one or more of a DPD actuator 402, a first receiver (Rx) 406, a PA 404, a Tx bandpass filter 412, an Rx bandpass filter 414, a low noise amplifier 416, a second receiver (Rx) 418, a PIMC block 420, an antenna 430, a full duplexer 410, and a PA cancellation block 422, or the like.

Passive intermodulation distortion and power amplifier distortion may be sensed at a full duplexer at a specific portion of a band. In some examples, in the communication system 400, the PA cancellation block 422 may be used to generate a cancellation signal to cancel the passive intermodulation distortion and power amplifier distortion sensed at the full duplexer. The cancellation signal may be based on a feedforward signal from the DPD 402. The cancellation signal may be used at the power amplifier to cancel the passive intermodulation distortion and power amplifier distortion sensed at the full duplexer.

In one example, the PIMC 420 may be used to generate the cancellation signal. In some examples, the PIMC 420 may be used to generate the cancellation signal by changing one or more parameters of the PIMC 420. In some examples, PA cancellation block 422 may be used to generate the cancellation signal.

In another example, the full duplexer 410 may be used to reduce the amount of power when compared to a baseline amount of power when the PIM distortion and PA distortion cancellation signal is not used. The analog aspect of the full duplexer 410 may be used to reduce the power and the digital aspect may be used to reduce the power. In addition, echo cancellation may be used. These aspects may be used to reduce the amount of power that is leaked from the PA 404. That is, the full duplexer 410 may be used to reduce the receive band leakage. As a result, the amount of loss in the duplexer 410 may be reduced.

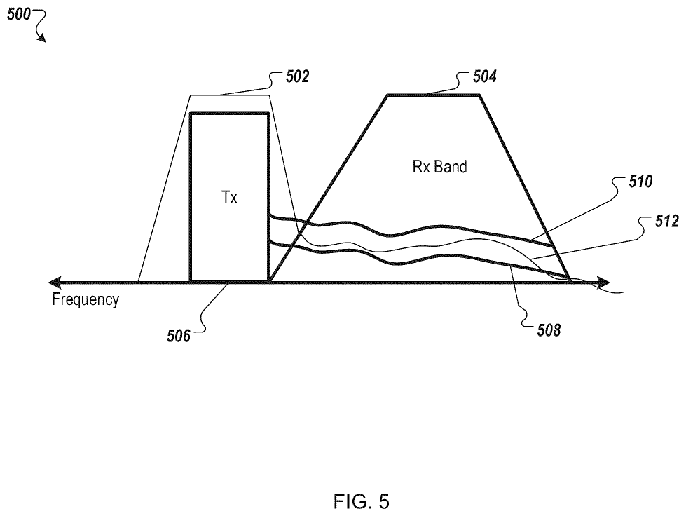

FIG. 5 illustrates a graph 500 for reducing receive band leakage in a full duplexer. A transmit filter 502 may be used to filter a transmit signal. A receive filter 504 may be used to filter a receive band. The transmit power 506 may be illustrated with various roll-offs that may fall into the receive band. The roll-off 510 may be reduced to the roll-off 508 by using digital pre-distortion. The roll-off 512 may be reduced by using the cancellation signal to cancel, on the receive path, the passive intermodulation distortion and power amplifier distortion sensed at the duplexer. In some examples, the digital pre-distorter may be used to reduce an amount of receive band leakage when compared to a baseline amount of receive band leakage when the digital pre-distorter is not used.

By reducing the amount of distortion at the duplexer, a low order filter may be used without a decrease in performance when compared to a baseline amount of performance when the PIM distortion and PA distortion cancellation signal is not used and the low-order filter is not used.

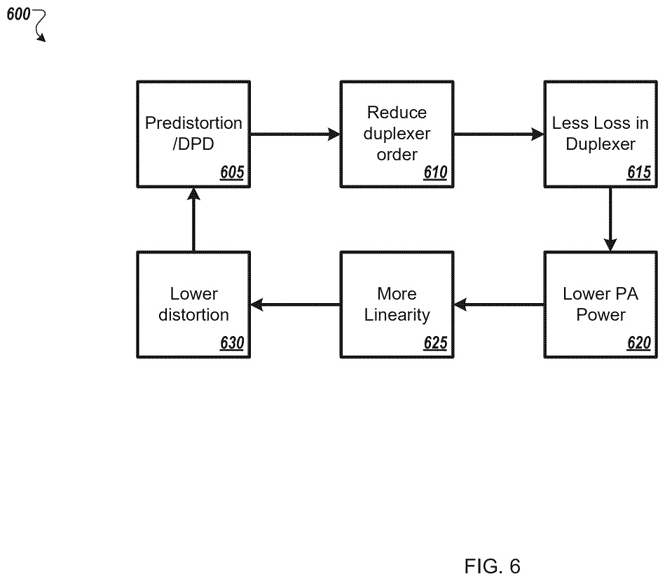

FIG. 6 illustrates a process flow 600 to reduce receive band leakage. The pre-distortion and/or digital pre-distortion (e.g., which may include PA cancellation), as shown by operation 605, may reduce duplexer order, as shown by operation 610, which may lead to less loss in the duplexer, as shown by operation 615, which may lower the amount of PA power, as shown by operation 620, which may lead to more linearity, as shown by operation 625, which may lead to lower distortion, as shown by operation 630, which may further reduce the power of the pre-distortion and/or digital pre-distortion, as shown by operation 605. The pre-distortion and/or digital pre-distortion may be more effective and/or may use less complexity with lower PA power, as shown by operation 620, and as the PA becomes more linear, as shown by operation 625. Consequently, the power of the pre-distortion and/or digital pre-distortion may be reduced because of the lower PA power and increased linearity.

In one example, at the duplexer, an amount of linearity may be increased when compared to a baseline amount of linearity when the PIM distortion and PA distortion cancellation signal is not used.

Reducing the amount of distortion at the duplexer may be applied in the optical domain. For example, wavelength division multiplexing (WDM) (which may be coarse WDM or dense WDM) may include channels and/or bands that may be positioned closely together in the frequency domain. As a result, diplexers, duplexers, multiplexers, or the like may be difficult to implement because of possible transmitter leakage into adjacent optical bands and/or channels. To lower the complexity of the diplexers, duplexers, and/or multiplexers, link training may be used to train the optical modulators to generate signals with increased linearity, which may reduce transmitter leakage into adjacent optical bands and/or channels. As a result, some of the link margin may be recovered.

In an example, a device may include a duplexer that may sense transmitter leakage into an adjacent optical band and/or channel. A processing device may use link training to reduce transmitter leakage into the adjacent optical band and/or channel. The device may include an optical modulator. The device may facilitate lower complexity of the duplexer without a reduction in performance compared to a baseline in which transmitter leakage into the adjacent optical band and/or channel occurs. The device may facilitate increased linearity when compared to a baseline amount of linearity in which transmitter leakage into the adjacent optical band and/or channel occurs. The device may facilitate an increase in link margin when compared to a baseline link margin in which transmitter leakage into the adjacent optical band and/or channel occurs.

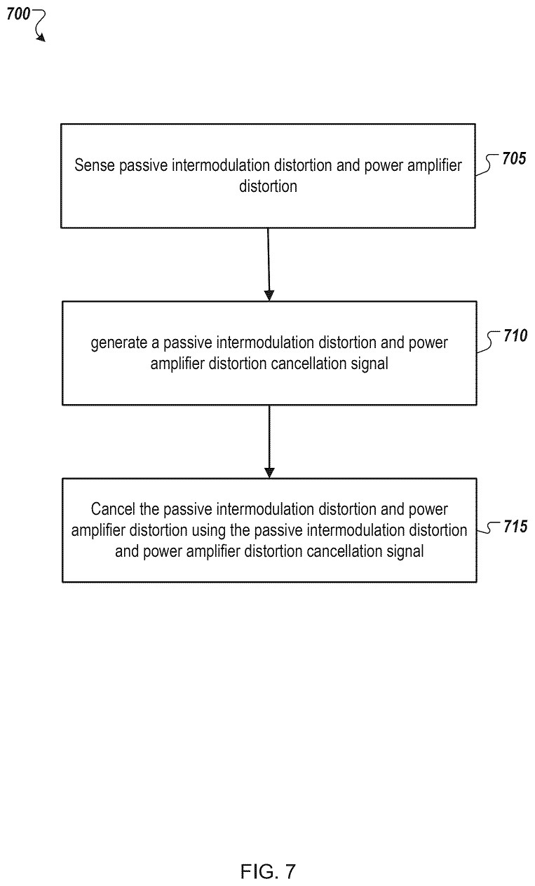

FIG. 7 illustrates a process flow for an example method 700 that may be used to reduce receive band leakage, in accordance with at least one example described in the present disclosure. The method 700 may be arranged in accordance with at least one example described in the present disclosure.

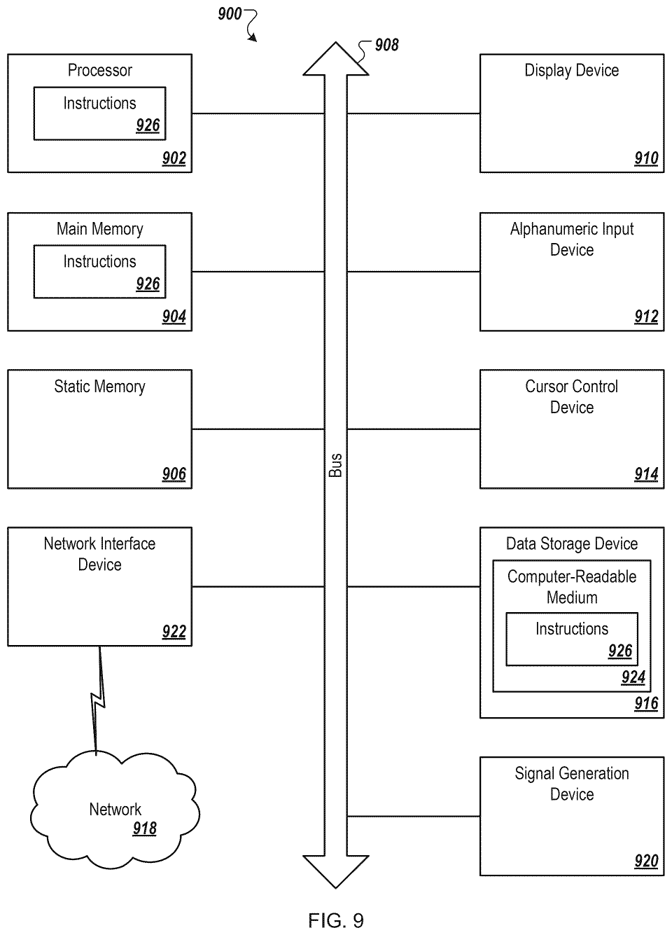

The method 700 may be performed by processing logic that may include hardware (circuitry, dedicated logic, etc.), software (such as is run on a computer system or a dedicated machine), or a combination of both, which processing logic may be included in the processing device (e.g., processor 902 of FIG. 9), or another device, combination of devices, or systems.

The method 700 may begin at block 705 where the processing logic may sense, at a full duplexer, passive intermodulation distortion and power amplifier distortion.

At block 710, the processing logic may generate, at a processing device, a passive intermodulation distortion and power amplifier distortion cancellation signal.

At block 715, the processing logic may cancel, on a receive path, the passive intermodulation distortion and power amplifier distortion using the passive intermodulation distortion and power amplifier distortion cancellation signal.

Modifications, additions, or omissions may be made to the method 700 without departing from the scope of the present disclosure. For example, in some examples, the method 700 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

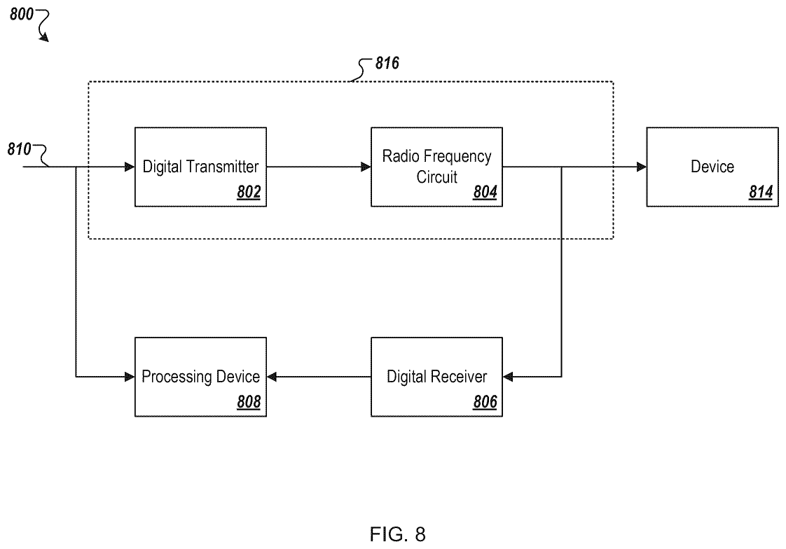

FIG. 8 illustrates a block diagram of an example communication system 800 configured for enhanced receiver sensitivity, in accordance with at least one example described in the present disclosure. The communication system 800 may include a digital transmitter 802, a radio frequency circuit 804, a device 814, a digital receiver 806, and a processing device 808. The digital transmitter 802 and the processing device 808 may be configured to receive a baseband signal via connection 810. A transceiver 816 may comprise the digital transmitter 802 and the radio frequency circuit 804.

In some examples, the communication system 800 may include a system of devices that may be configured to communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may be configured to communicate via one or more wireless connections. For example, the communication system 800 may include one or more devices configured to transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may be configured to obtain a baseband signal, perform one or more operations to the baseband signal to generate a modified baseband signal, and transmit the modified baseband signal, such as to one or more loads.

In some examples, the communication system 800 may include one or more communication channels that may communicatively couple systems and/or devices included in the communication system 800. For example, the transceiver 816 may be communicatively coupled to the device 814.

In some examples, the transceiver 816 may be configured to obtain a baseband signal. For example, as described herein, the transceiver 816 may be configured to generate a baseband signal and/or receive a baseband signal from another device. In some examples, the transceiver 816 may be configured to transmit the baseband signal. For example, upon obtaining the baseband signal, the transceiver 816 may be configured to transmit the baseband signal to a separate device, such as the device 814. Alternatively, or additionally, the transceiver 816 may be configured to modify, condition, and/or transform the baseband signal in advance of transmitting the baseband signal. For example, the transceiver 816 may include a quadrature up-converter and/or a digital to analog converter (DAC) that may be configured to modify the baseband signal. Alternatively, or additionally, the transceiver 816 may include a direct RF sampling converter that may be configured to modify the baseband signal.

In some examples, the digital transmitter 802 may be configured to obtain a baseband signal via connection 810. In some examples, the digital transmitter 802 may be configured to up-convert the baseband signal. For example, the digital transmitter 802 may include a quadrature up-converter to apply to the baseband signal. In some examples, the digital transmitter 802 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 802.

In some examples, the transceiver 816 may include one or more subcomponents that may be used in preparing the baseband signal and/or transmitting the baseband signal. For example, the transceiver 816 may include an RF front end (e.g., in a wireless environment) which may include a PA, a digital transmitter (e.g., 802), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 804) of the transceiver 816 may be synchronized with the resource controller via the S-plane device, which may contribute to high-accuracy timing with respect to a reference clock.

In some examples, the transceiver 816 may be configured to obtain the baseband signal for transmission. For example, the transceiver 816 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 816 may be configured to generate a baseband signal for transmission. In these and other examples, the transceiver 816 may be configured to transmit the baseband signal to another device, such as the device 814.

In some examples, the device 814 may be configured to receive a transmission from the transceiver 816. For example, the transceiver 816 may be configured to transmit a baseband signal to the device 814.

In some examples, the radio frequency circuit 804 may be configured to transmit the digital signal received from the digital transmitter 802. In some examples, the radio frequency circuit 804 may be configured to transmit the digital signal to the device 814 and/or the digital receiver 806. In some examples, the digital receiver 806 may be configured to receive a digital signal from the RF circuit 804 and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 816. In instances in which the processing device 808 is a standalone device or system, the processing device 808 may be configured to communicate with additional devices and/or systems remote from the processing device 808, such as the transceiver 816 and/or the device 814. For example, the processing device 808 may be configured to send and/or receive transmissions from the transceiver 816 and/or the device 814. In some examples, the processing device 808 may be combined with other elements of the communication system 800.

FIG. 9 illustrates a diagrammatic representation of a machine in the example form of a computing device 900 within which a set of instructions, for causing the machine to perform any one or more of the methods discussed herein, may be executed. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device (e.g., a processor) 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also include one or more special-purpose processing devices such as an ASIC, a FPGA, a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method for reducing receive band leakage, comprising:
sensing, at a full duplexer, passive intermodulation (PIM) distortion and power amplifier (PA) distortion;
generating, at a processing device, a PIM distortion and PA distortion cancellation signal; and
canceling, on a receive path, the PIM distortion and PA distortion using the PIM distortion and PA distortion cancellation signal.

2. The method of claim 1, further comprising:
reducing, at the duplexer, an amount of power when compared to a baseline amount of power when the PIM distortion and PA distortion cancellation signal is not used.

3. The method of claim 1, further comprising:
reducing, using a digital pre-distorter, an amount of receive band leakage when compared to a baseline amount of receive band leakage when the digital pre-distorter is not used.

4. The method of claim 1, further comprising:
using a low-order filter without a reduction in performance when compared to a baseline performance when the PIM distortion and PA distortion cancellation signal is not used and the low-order filter is not used.

5. The method of claim 1, further comprising:
reducing, at the duplexer, an amount of loss when compared to a baseline amount of loss when the PIM distortion and PA distortion cancellation signal is not used.

6. The method of claim 1, further comprising:
increasing, at the duplexer, an amount of linearity when compared to a baseline amount of linearity when the PIM distortion and PA distortion cancellation signal is not used.

7. The method of claim 1, wherein the PIM distortion and PA distortion cancellation signal is based on a feedforward signal from a digital pre-distorter.

8. A device, comprising:
a duplexer operable to sense passive intermodulation (PIM) distortion and power amplifier (PA) distortion; and
a processing device operable to generate a PIM distortion and PA distortion cancellation signal to cancel the PIM distortion and the PA distortion.

9. The device of claim 8, wherein the PIM distortion and PA distortion cancellation signal is generated by changing one or more parameters of the processing device.

10. The device of claim 8, wherein the duplexer is operable to reduce an amount of power when compared to a baseline amount of power when the PIM distortion and PA distortion cancellation signal is not used.

11. The device of claim 8, further comprising a digital pre-distorter operable to reduce an amount of receive band leakage when compared to a baseline amount of receive band leakage when the digital pre-distorter is not used.

12. The device of claim 8, wherein reducing the PIM distortion and the PA distortion facilitates using a low-order filter without a reduction in performance when compared to a baseline performance when the PIM distortion and PA distortion cancellation signal is not used and the low-order filter is not used.

13. The device of claim 8, wherein reducing the PIM distortion and the PA distortion reduces an amount of loss in the duplexer when compared to a baseline amount of loss when the PIM distortion and the PA distortion is not reduced.

14. The device of claim 8, wherein the PIM distortion and PA distortion cancellation signal is based on feedforward from a digital pre-distorter.

15. A device, comprising:
a duplexer operable to sense transmitter leakage into one or more of an adjacent optical band or channel; and
a processing device operable to use link training to reduce transmitter leakage into one or more of the adjacent optical band or channel.

16. The device of claim 15, further comprising one or more of coarse wave division multiplexing or dense wave division multiplexing.

17. The device of claim 15, further comprising an optical modulator operable to minimize transmitter leakage into the one or more of the adjacent optical band or channel.

18. The device of claim 15, further comprising an optical modulator operable to facilitate lower complexity of the duplexer without a reduction in performance when compared to a baseline in which transmitter leakage into one or more of the adjacent optical band or channel occurs.

19. The device of claim 15, further comprising an optical modulator operable to facilitate increased linearity when compared to a baseline amount of linearity in which transmitter leakage into one or more of the adjacent optical band or channel occurs.

20. The device of claim 15, further comprising an optical modulator operable to facilitate an increase in link margin when compared to a baseline link margin in which transmitter leakage into one or more of the adjacent optical band or channel occurs.
